(19) United States
(12) Patent Application Publication
(10) Pub. No.: US 2012/0133624 A1
(43) Pub. Date: May 31, 2012

(54) DISPLAY PANEL

(75) Inventors: Jean Luc Laurent Castagner, Oxford (GB); David James Montgomery, Oxford (GB); James Rowland Suckling, Oxford (GB); Peter John Roberts, Oxford (GB)

(73) Assignee: SHARP KABUSHIKI KAISHA, Osaka (JP)

(21) Appl. No.: 13/375,393

(22) PCT Filed: May 28, 2010
(86) PCT No.: PCT/JP2010/059483

§ 371 Date: Feb. 15, 2012

(30) Foreign Application Priority Data
Jun. 2, 2009 (GB) 0909452.5

(51) Int. Cl. G09G 5/00

(52) U.S. Cl. 345/207

(57) ABSTRACT

A display panel incorporates the functionality to determine the three dimensional position of a light reflecting or emitting object (400, 401, 410) in front of a display surface (100). An array of sensors (310) is disposed in the panel and provided with optical arrangements such as apertures in masks (321, 331) within the panel. These arrangements prevent light incident normally on the display surface (100) from reaching the sensors (310) but allow obliquely incident light (602, 604) to reach the sensors (310). The object position is determined by analyzing the sensor responses.

### TECHNICAL FIELD

The present invention relates to a display panel. Such a panel may be used, for example, for the detection of oblique incident light upon an array of TFT-integrated light sensitive areas with applications to the three-dimensional detection of the position of one or many user-controlled pen/fingertip/scattering objects above or below a display panel surface.

### BACKGROUND ART

US28150913A1 (Carr & Ferrell LLP)

This patent describes a self-contained optical projection-based design in which an image is projected on a screen while a camera detects the interaction of an illuminated object with the projected image. A field of view of the camera allows the user to operate within a set distance from the projected image. Nevertheless, given the optical configuration, the whole system occupies a significant volume.

WO28065601A2 (Philips Electronics)

This patent describes a hand-held pointer device with a directional illumination detected by a set of detectors at different positions for 3D control of an object rendered on the screen of a display monitor.

US28007542A1 (Winthrop Shaw Pittman LLP)

This patent describes a waveguide-based optical touchpad using total internal reflection of light emitted within optical layers to provide, in various embodiments such as an aperture optical system imaging the reflected light on an array of sensors, information on the close proximity of scatterers relatively to the surface.

US27139391A1 (Siemens Aktiengesellshaft)

This patent describes an input device having a flexible display and a three-dimensional sensitive layer for acquiring inputs, embedded within the display. In this, contact has to be affected between a user-controlled pen and the display, while an embedded flexible grid of resistive material senses pressure intensity and contact location on the display, thus providing the necessary input for three-dimensionality. However, this does not constitute true three-dimensional input as the third dimension is virtually substituted by pressure. Additionally, this arrangement does not use optical means to gather three-dimensional input.

US28100593A1 (Shemwell Mahamedi LLP)

This patent describes the use of objects such as pens interacting with a display integrated light sensor array by means of detection of the light that is cast over the display interface. From the characteristic of the light variation, a determination is made as to whether the variation in light is to be interpreted as an input or to be ignored.

US28066972A1 (Planar Systems, Inc.)

This patent describes an optical touchpad that provides information about the position of an object in three-dimensions through light being internally reflected in a waveguide, thereafter scattered by an object at or near the surface interface. Depth information is said to be retrieved through the variation in signal strength induced on each sensor.

There is an increasing interest in touch-sensitive panels, as they provide a simplified means of interaction with the user through the measurement of two-dimensional positioning of user-controlled objects on the display panel surface.

More particularly, the measurement of three-dimensional positioning of user-controlled objects above or below the display panel surface provides even greater user interaction, as one more degree of freedom is added.

As far as is known, no true detection of three-dimensional positioning of user-controlled objects has been achieved by optical means. However, prior art is found relative to the distinction between hovering above the panel surface and touching the panel surface by user-controlled objects.

### SUMMARY OF INVENTION

According to a first aspect of the invention, there is provided a display panel for use in determining a three dimensional position of an object with respect to a display surface of the panel, comprising a plurality of light sensors spaced apart and disposed in the panel and a plurality of optical arrangements disposed in the panel, each of the arrangements being arranged to cooperate with at least one of the sensors to prevent light which is incident normally on the display surface from reaching the at least one sensor and to permit at least some light which is incident obliquely on the display surface to reach the at least one sensor, the panel comprising or being associated with a processor for determining the position of the object as Cartesian components with respect to first and second axes in the display surface and a third axis perpendicular to and with an origin at the display surface.

According to a first aspect of the invention, there is provided a display panel for use in determining a three dimensional position of an object with respect to a display surface of the panel, comprising a plurality of light sensors spaced apart and disposed in the panel and a plurality of optical arrangements disposed in the panel, each of the arrangements being arranged to cooperate with at least one of the sensors to prevent light which is incident normally on the display surface from reaching the at least one sensor and to permit at least some light which is incident obliquely on the display surface to reach the at least one sensor, the panel comprising or being associated with a processor for determining the position of the object as Cartesian components with respect to first and second axes in the display surface and a third axis perpendicular to and with an origin at the display surface.

Each of the arrangements may comprise a prism arranged to deflect normally incident light away from the at least one sensor by total internal reflection.

Each of the arrangements may comprise a plurality of louvres which are angled to define at least one oblique direction from which light is permitted to reach the at least one sensor.

Each of the arrangements may comprise a diffractive arrangement. Each of the diffractive arrangements may comprise a wire grid. As an alternative, each of the arrangements may comprise a plurality of interference filters.

The sensors may be sensitive to visible light. The panel may comprise a display backlight, the sensors being sensitive to light from the backlight reflected from an object in front of the display surface.

The arrangements may be arranged as a two dimensional array behind the display surface.

Each of the arrangements may cooperate with the at least one sensor such that the at least one sensor receives light incident on the display surface in substantially only first and second solid angles substantially centred on first and second directions, respectively, which are on opposite sides of the display surface normal and in an azimuthal plane substantially perpendicular to the display surface. The first and second directions may be substantially symmetrical about the display normal. The array may comprise a first subarray whose azimuthal planes are parallel to each other and a second subarray whose azimuthal planes are perpendicular to the azimuthal planes of the first subarray.

Each of the arrangements may cooperate with the at least one sensor such that the at least one sensor receives light incident on the display surface in substantially only one solid angle substantially centred on a predetermined direction. The array may comprise first to fourth subarrays with the azimuthal components of the predetermined directions of the second to fourth subarrays being disposed at substantially 90°, 180° and 270°, respectively, to the azimuthal component of the predetermined direction of the first subarray.

The arrangements may cooperate with the sensors to define a plurality of sets of the sensors such that the sensors of each set have a same angle of view and the angles of view of the sensors of different ones of the sets are different.

The processor may be arranged to analyse the outputs of the sensors of each set for a visual feature of an image to which the set of sensors is sensitive and to determine the position of the object from the visual features. The visual feature may comprise the location of the sensor of the set sensing a highest light intensity. As an alternative, the visual feature may comprise the location on the display surface of a centre of light intensity sensed by the sensors of the set.

The sensors of first and second of the sets may have angles of view whose azimuths are in opposite directions parallel to the first axis. The angles of view of the sensors of the first and second sets may have elevation angles of +θ1 and −θ1 relative to the display surface and the processor may be arranged to determine the component of the object position with respect to the first axis as a mean position between the positions of the visual features with respect to the first axis. The processor may be arranged to determiner the component of a first object position with respect to the third axis as (d1·tan(θ1))/2, where d1 is the distance between the visual features with respect to the first axis.

The sensors of third and fourth of the sets may have angles of view whose azimuths are in opposite directions parallel to the second axis. The angles of view of the sensors of the third and fourth sets may have elevation angles of +θ2 and −θ2 relative to the display surface and the processor may be arranged to determine the component of the object position with respect to the second axis as a mean position between the positions of the visual features with respect to the second axis. The processor may be arranged to determine the component of a second object position with respect to the third axis as (d2·tan(θ2))/2, where d2 is the distance between the visual features with respect to the second axis, and to determine the object position with respect to the third axis as a mean of the first and second object positions.

According to a second aspect of the invention, there is provided a method of determining a three dimensional position of an object with respect to a display surface of a display panel comprising a plurality of light sensors spaced apart and disposed in the panel and a plurality of optical arrangements disposed in the panel, each of the arrangements being arranged to cooperate with at least one of the sensors to prevent light which is incident normally on the display surface from reaching the at least one sensor and to permit at least some light which is incident obliquely on the display surface to reach the at least one sensor, the method comprising determining the position of the object as Cartesian components with respect to first and second axes in the display surface and a third axis perpendicular to and with an origin at the display surface.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

FIG. 1. Two-dimensional context for optical touch-sensitive panels.

FIG. 2. Three-dimensional context for optical touch-sensitive panels.

FIG. 3.a Cross-sectional view of the various TFT layers that constitute the first embodiment of the invention.

FIG. 3.b Cross-sectional view of the TFT element that constitutes the first embodiment of the invention and field of view created on the sensor.

FIG. 4. Top-view of the various TFT layers that constitute the first embodiment of the invention.

FIG. 5. Basic principle of operation of the first embodiment in the perfect case approximation.

FIG. 6. Illustration of signals induced on sensors for the first embodiment of the invention.

FIG. 7.a Contour visualisation of signals induced on an array of sensors for the first embodiment of the invention.

FIG. 7.b Experimental results obtained with structure depicted in FIGS. 3.a and 3.b and FIG. 4.

FIGS. 8.a to 8.c Another embodiment of the invention using distinct aperture layers on successively adjacent sensors. FIG. 8.a Central incidence field of view on sensor. FIG. 8.b. Left-oblique incidence field of view on sensor. FIG. 8.c. Right-oblique incidence field of view on sensor.

FIGS. 8.d and 8.e show two patterns of sensitivity directions.

FIG. 9. Another embodiment of the invention using a mask to block central incidence light.

FIG. 10. Another embodiment of the invention using a mask to block central incidence light of which thickness is increased to create a virtual lens by depositing a higher refractive index material on top.

FIG. 11. Another embodiment of the invention using total internal reflection with a prism of lower refractive index than its embedding layer to block central incidence light.

FIG. 12. Similar to embodiment depicted in FIG. 11, but with an inverted prism structure with a higher refractive index.

FIG. 13. Another embodiment of the invention using angled absorbing masks to block central incidence light.

FIG. 14.a. Another embodiment of the invention similar to embodiment depicted in FIG. 10, but having a mask blocking the central incidence light separated from the lens, while a lens is positioned on the side to image right- and left-incidence light on adjacent sensors.

FIG. 14.b. Another embodiment of the invention having lenses separated by mask portions and aligned with pairs of sensors.

FIG. 15. Another embodiment of the invention using wire-grids as a mean of in-coupling as a function of incidence angle light from right- or left-oblique incidence, thereby blocking the central incidence light.

FIG. 16. Another embodiment of the invention using stacks of interference filters as a mean of in-coupling as a function of incidence angle light from right- or left-oblique incidence, thereby blocking the central incidence light.

FIG. 17 is a flow diagram illustrating the operation of a processor of an embodiment of the invention.

FIG. 18 is a flow diagram of a first example of the operation illustrated in FIG. 17.

FIG. 19 is a flow diagram of a second example of the operation illustrated in FIG. 17.

### DESCRIPTION OF EMBODIMENTS

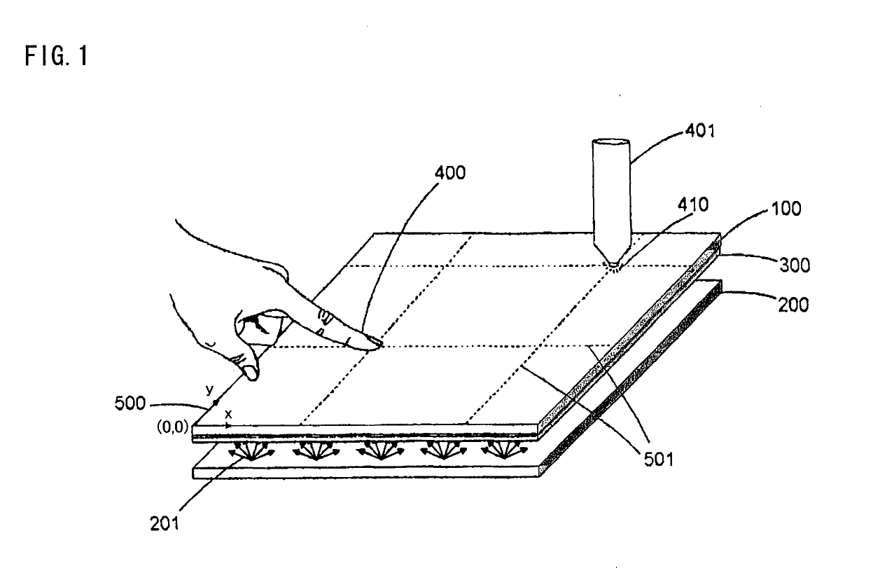

FIG. 1 illustrates a two-dimensional context for touch-sensitive panels using optical means for the two-dimensional detection of the position of objects on the LCD display panel 100 surface.

In this type of system, one or many user-controlled light scattering objects such as a finger 400 or object 401 interact with an array of optical sensors embedded within a TFT layer 300 of a display panel by means of light scattered by 400 or 401 through 300 to 100 as a result of being illuminated by a backlight element 200 emitting light through semi-transparent layers 100 and 300.

Alternatively, one or many user-controlled light emitting objects such as 410 may also interact directly with an array of optical sensors embedded within a TFT layer 300.

In this type of TFT embedded light sensor array 300, multiple light scattering or emitting objects may simultaneously interact optically with 300 and be spatially localised on the display panel 100 surface relatively to a reference or coordinate system 500 as distinct pattern entities from a pixelated image, each pixel of which represents a scaled signal generated by one or many light sensors embedded in the TFT element 300.

TFT element 300 may also comprise various layers that modify the passage of scattered or emitted light from one or many light scattering or light emitting objects through to one or many light sensors in a suitable manner with a desired effect.

In some cases, TFT element 300 may incorporate layers that will define an optical configuration allowing the differentiation between a scattering/emitting object in contact with LCD display panel surface 100 and a light scattering or light emitting object hovering above LCD display panel surface 100.

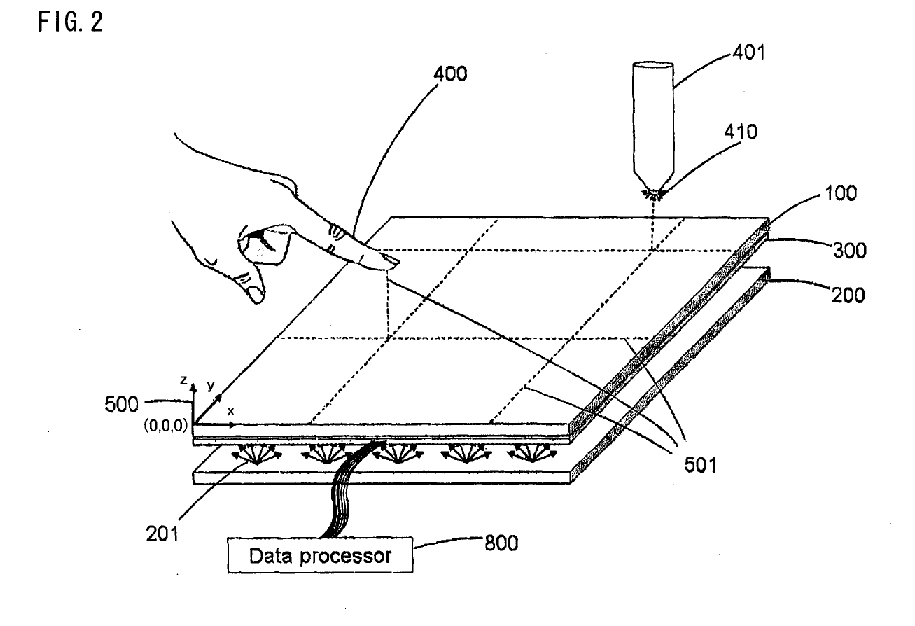

FIG. 2 illustrates the problem of three-dimensional detection of the position of one or many user-controlled light scattering objects such as a finger 400 or object 401 interacting with an array of optical sensors embedded within a TFT layer 300 of a display panel by means of light scattered by 400 or 401 through 300 to 100 as a result of being illuminated by a backlight element 200 emitting light through semi-transparent layers 100 and 300.

Alternatively, one or many user-controlled light emitting objects such as 410 may also interact directly with an array of optical sensors embedded within the TFT layer 300.

In this type of TFT embedded light sensor area 300, multiple objects may simultaneously interact optically with 300 and be spatially localised above the display panel 100 surface relative to a three-dimensional reference (or Cartesian coordinate) system 500 as distinct pattern entities from a pixelated image, each pixel of which represents a scaled signal generated by one or many light sensors embedded in a TFT element 300.

TFT element 300 may also comprise various layers that modify the passage of scattered or emitted light from scattering or emitting objects through to one or many light sensors in a suitable manner with a desired effect.

If the LCD display panel 100 surface is made of a flexible material that allows for local deformations when submitted to pressure effected by one or many light scattering or light emitting objects, TFT embedded light sensor array 300 may also provide three-dimensional detection of the position of the one or many light scattering or light emitting objects effecting pressure on the LCD display panel 100 surface below the LCD display panel 100 surface, resulting in negative positional information relatively to the axis Z of reference 500, normal to the LCD display panel 100 surface.

### First Embodiment of the Invention

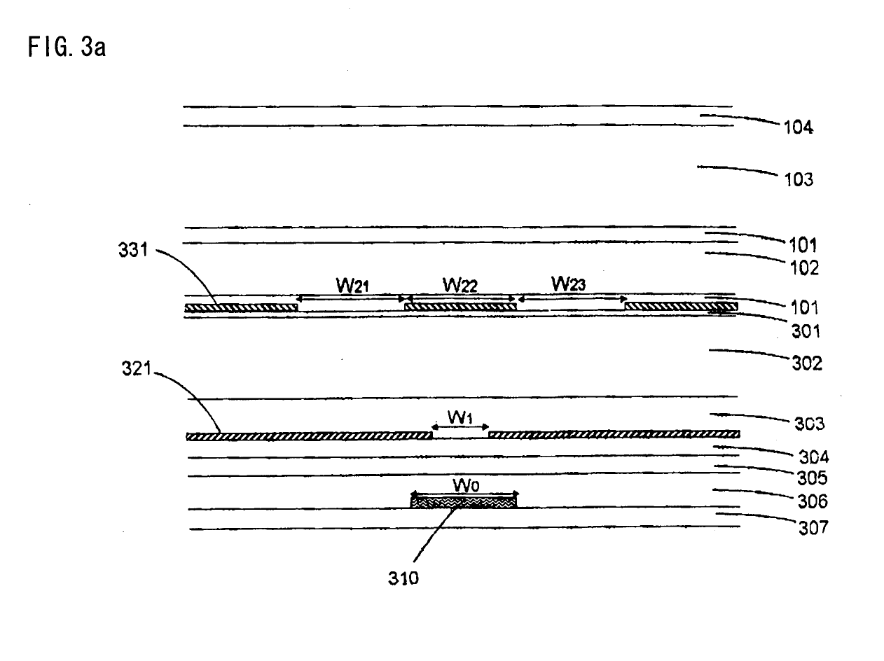

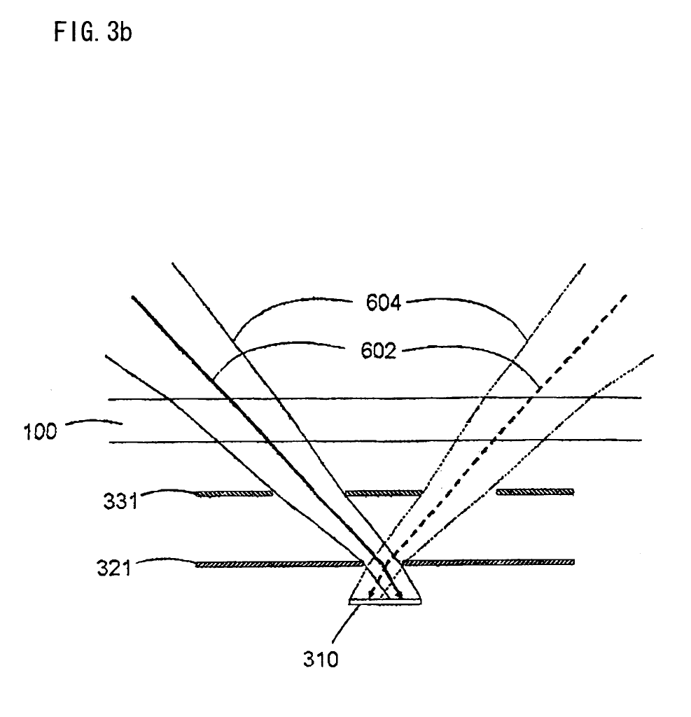

FIG. 3.a and FIG. 3.b illustrate a first embodiment of the present invention, which may, for example, be used in conjunction with the arrangements disclosed in GB2439118 and GB2439098.

In this, one or many sensors 310 which may be of rectangular, square, circular, elliptic or arbitrary surface shape, endowed with a homogeneous or inhomogeneous surface photo-electric response, are embedded within, but not restricted to, a TFT substrate of an LCD display panel, comprising various layers, but not restricted to the particular arrangement described in FIG. 3.a, both relatively to the spatial distribution of the layer constituents and to the nature of the layer constituents.

In the particular configuration described in FIG. 3.a as an exemplification of the first embodiment, one or many sensors 310 are embedded within a layer, for example, of SiO2 306, successively covered by layers of SiN 305 and SiO2 304, on top of which a mask layer 321 is deposited.

A layer 303 and layer 302 produce a flat surface on which is deposited an ITO layer 301.

Layer 331 is deposited on top of layer 301.

LCD display panel 100 is constituted by the liquid crystal alignment layers 101 sandwiching the LC material layer 102.

A protective glass-type layer 103 is added to provide mechanical stability of the before mentioned various layers. Polarisers 104 and 307 are provided on opposite sides of this assembly.

The first part of the optical arrangement constituting the first embodiment of the invention comprises, for example, an extended Ti/Al—Si/Ti layer 321, normally used as a contact electrode, so as to form an aperture of width W1 which may be of rectangular, square, circular, elliptic or arbitrary shape having the effect of optically restricting the field of view of sensor 310.

The second part of the optical arrangement constituting the first embodiment comprises, for example, an extended Mo/Al layer 331, so as to form a single aperture which may be of rectangular, square, circular, elliptic or arbitrary annulus shape having widths W23 and W21 equal or varying according to the conformation of the annulus shape, with its centrally opaque region placed relatively to sensor 310 so as to produce a second restriction in the field of view of sensor 310, thus creating an overall field of view constituted by the combination of aperture layers 321 and 331 of the desired angular profile with respect to the polar and azimuth angles relative to the normal of the LCD display panel 100 surface denoted as Z in the coordinate or reference system 500 of FIG. 2.

The second part of the optical arrangement constituting the first embodiment that comprises an extended Mo/Al layer 331 described above can also form a set of two or more spatially distinct apertures which may be of rectangular, square, circular, elliptic or arbitrary shapes, having equal or varying dimensions according to the conformation of each aperture and equal or varying successive separation distances W22, placed relatively to sensor 310 to produce a second restriction in the field of view of sensor 310, thus creating an overall field of view constituted by the combination of aperture layers 321 and 331 of the desired angular profile with respect to the polar and azimuth angles relative to the normal of the LCD display panel 100 surface denoted as Z in the reference system 500 of FIG. 2.

The field of view created on sensor 310 is depicted in FIG. 3.b, where 604 represent a bi-directional field of view having an angular spread around directions depicted by rays 602 corresponding to the direction of maximum power of incident light on sensor 310. Thus, the sensor 310 receives light in the first and second solid angles 604 substantially centred on first and second directions represented by rays 602 on opposite sides of a normal to the display through the sensor 310. The directions 602 are in an azimuthal plane which is the plane of the drawing in FIG. 3.b.

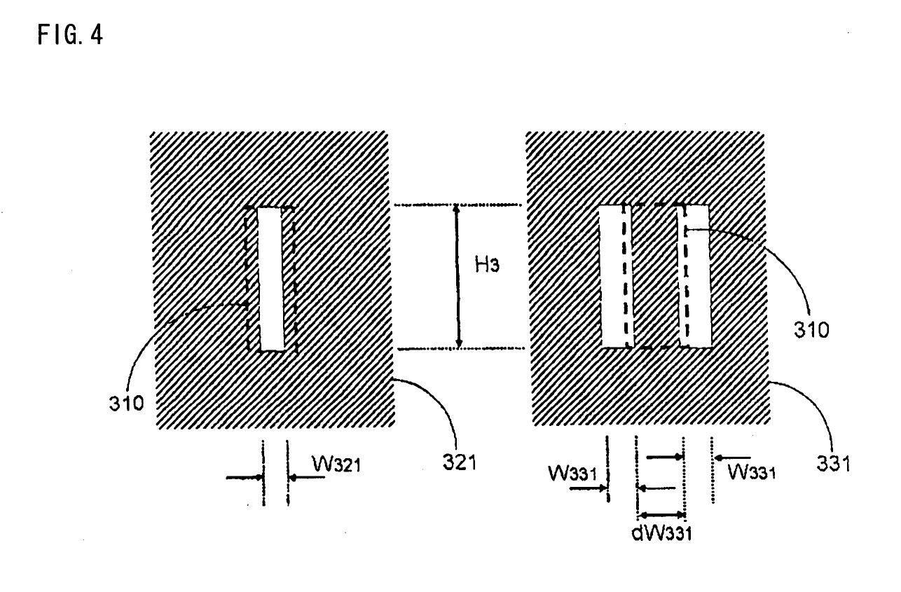

An example of the first embodiment is more specifically illustrated in FIG. 4. The layer 321 provides one or more rectangular apertures centred on one or many sensors 310. The layer 331 provides one or many sets of two spatially distinct apertures separated in one of the reference 500 directions by distance dW331, centred on one or many sensors 310.

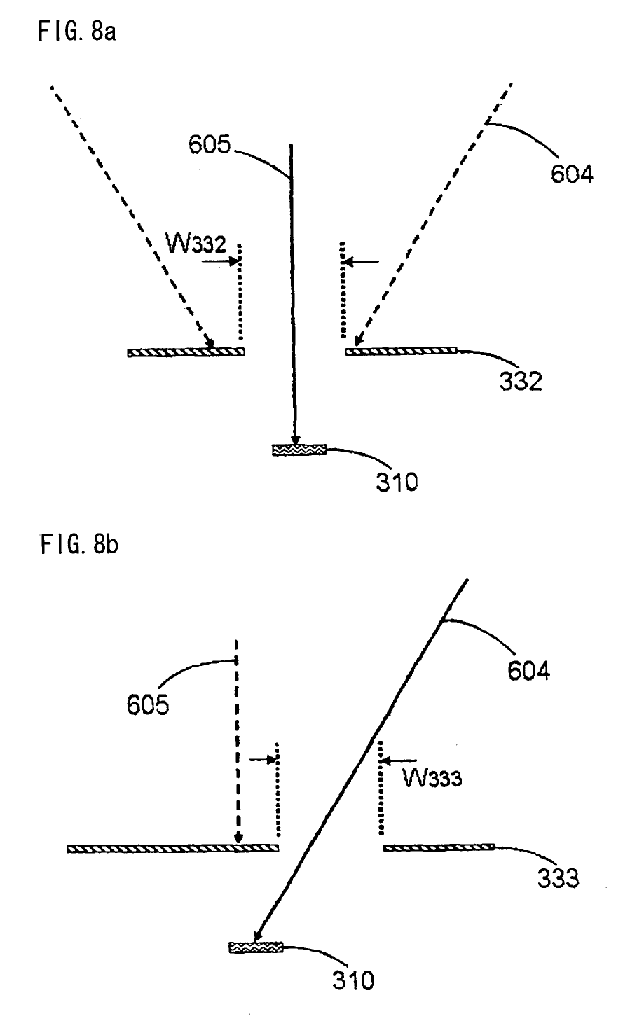

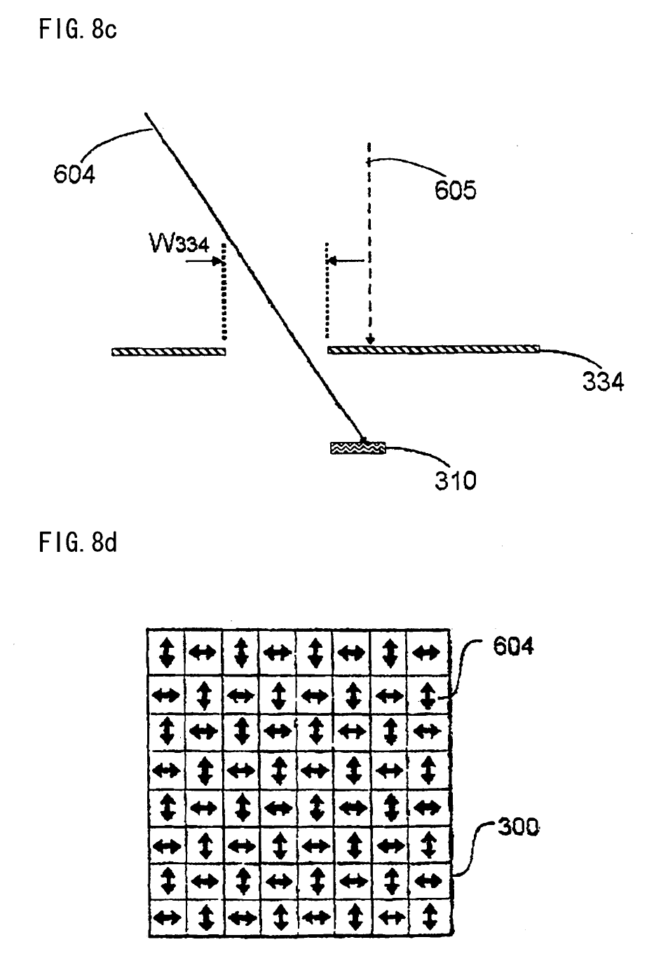

Arrangements of two or more sets of layers 321 and 331 with an array of sensors 310 can be constituted regularly with respect to one of the reference 500 directions or regularly alternating between arbitrary directions in the plane of layers 321 and 331 or irregularly with respect to one of the reference 500 directions or irregularly with respect to arbitrary directions in the plane of layers 321 and 331. Two examples of such configurations are depicted in FIG. 8.d and FIG. 8.e, where rays 604 indicate the direction of the field of view on top of each sensor embedded within TFT element 300 with respect to X or Y direction of reference 500. In FIG. 8e, the sensors are thus arranged as four sub-arrays of a two dimensional array where the azimuthal components (indicated at 604) of the directions in which the sensors receive light are such that the azimuthal components of the second to fourth sub-arrays are at 90°, 180° and 270°, respectively to that of the first sub-array.

In this context, ‘arbitrary’ can also refer to a random choice of configurations obtained with a particular manufacturing process or to a pre-established choice of configurations to produce a specific overall field of view for sensors 310.

The particular case where layers 321 and 331 constitute one or many sets of spatially distinct apertures as depicted in FIG. 4 centred on sensors 310 results in a bi-directional field of view for sensor 310.

Additionally, there is no restriction for this embodiment in the wavelength of light incident on sensor 310, apart from being included within the sensor chromatic sensitivity. This embodiment may use a very narrow range of wavelengths such as in a Laser source or a plurality of Laser sources or a broad range of wavelengths.

Principle of Operation

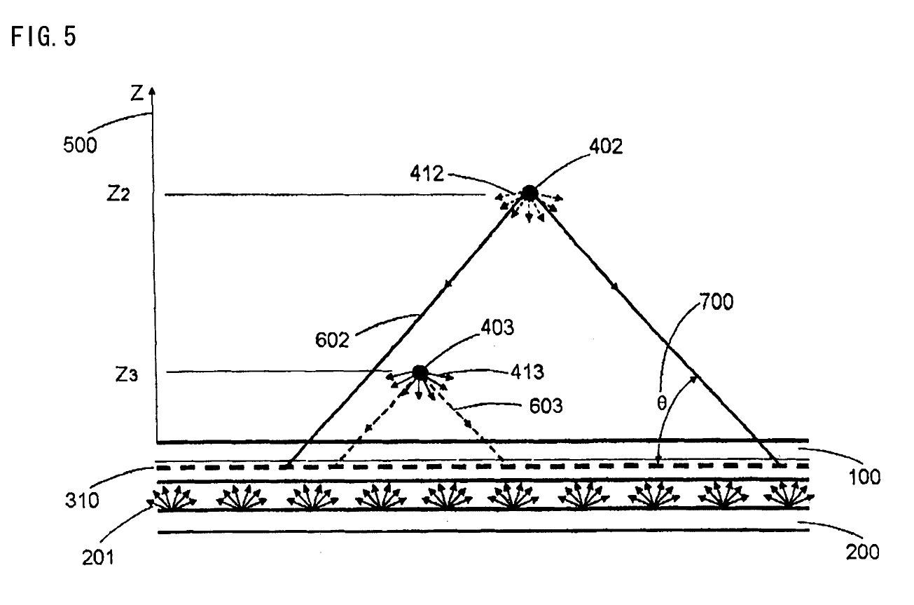

FIG. 5 illustrates the basic principle of operation for the configuration depicted in FIG. 4, in which a very narrow bi-directional field of view is created for sensor 310.

In this, light scattering or light emitting objects 402 or 403 scatter or emit light incident on sensors 310 in a manner related to their position relative to the Z axis of reference 500.

Only rays 602 and 603 that are scattered/emitted within the angular field of view of a sensor 310 will induce an electric signal through sensor 310.

In the perfect case depicted in FIG. 5 where the bi-directionality in the field of view of sensors 310 is angularly narrow so as to induce an electric signal through only two sensors 310, the separation distance between the two sensors 310 is linearly related to the height of scattering/emitting objects 402 or 403.

More specifically, object 402 scatters/emits light rays 412, but only light rays 602 which are scattered/emitted within the narrow bi-directional field of view of sensors 310 will induce an electric signal through only two sensors 310, the separation distance of which is linearly related to the height Z2 of scattering/emitting object 402.

Similarly, object 403 scatters/emits light rays 413, but only light rays 603 which are scattered/emitted within the narrow bi-directional field of view of sensors 310 will induce an electric signal through only two sensors 310, the separation distance of which is linearly related to the height Z3 of scattering/emitting object 403.

The separation distance between maxima is obtained through a data processor 800 (shown in FIG. 2) connected to sensor layer 300, analysing the two-dimensional positions of signal maxima that correspond to light incident on sensors at the angle of maximum sensitivity θ700, as depicted in FIG. 5.

The mathematical formula relating the height Z of the scattering/emitting object to the separation distance d of its maxima is then given by:

$$Z = d * \frac{tan ( θ )}{2}$$

The data processor 800 forms part of or is associated with the display panel and determines the position of the object 400, 401 as Cartesian components with respect to first and second axes (x and y in FIG. 2) in the display surface and a third axis (z in FIG. 2) perpendicular to the display surface. The origin ((0,0,0) in FIG. 2) of the Cartesian coordinate system is at the display surface.

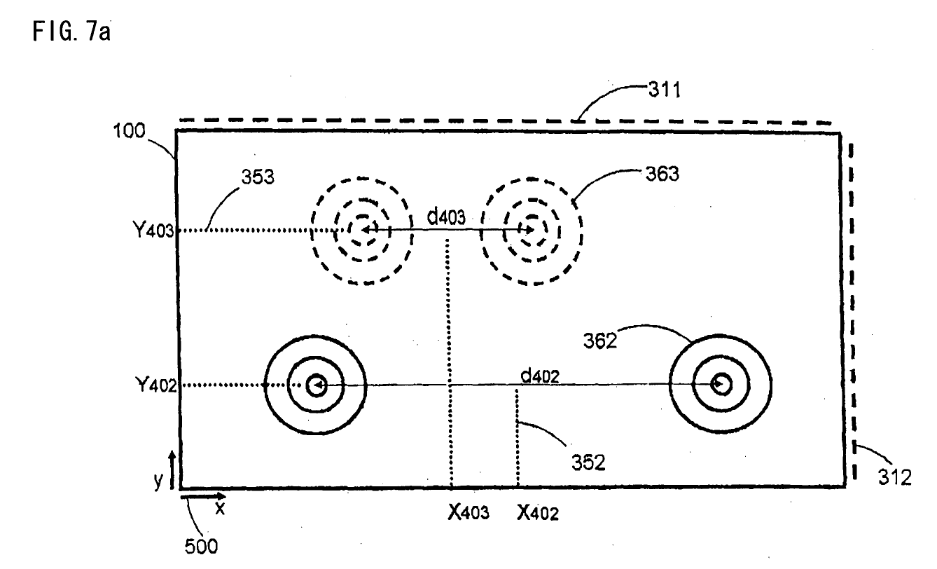

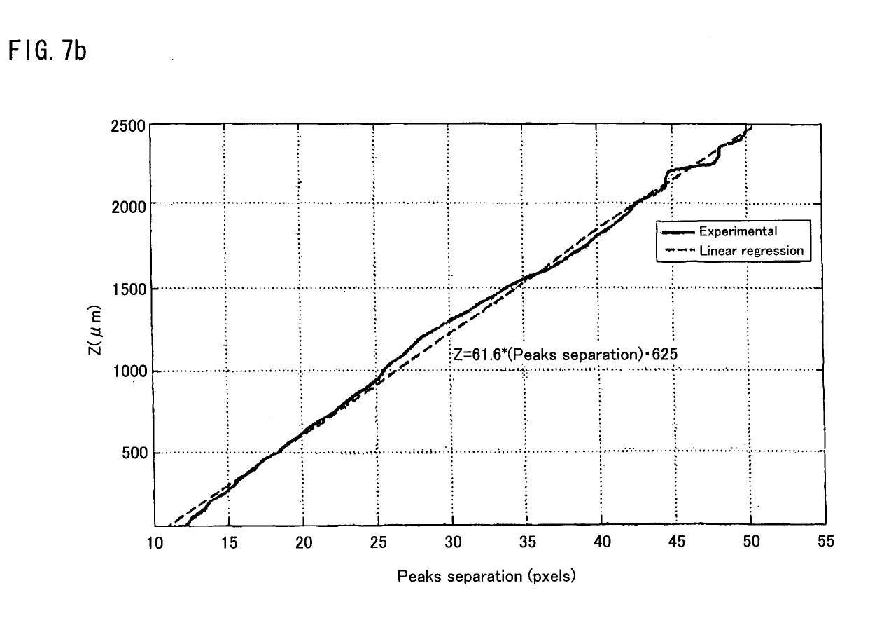

For example, in the case depicted in FIG. 7.a for scattering/emitting object 402, the corresponding height Z₄₀₂ is given by:

$${Z}_{402} = {d}_{402} * \frac{tan ( θ )}{2} ,$$

In the imperfect case where the bi-directionality in the field of view of sensors 310 is not angularly narrow, so that an electric signal is induced through more than two sensors 310, the separation distance between the sensors 310 generating the most important or largest signal is still linearly related to the height of the scattering/emitting objects.

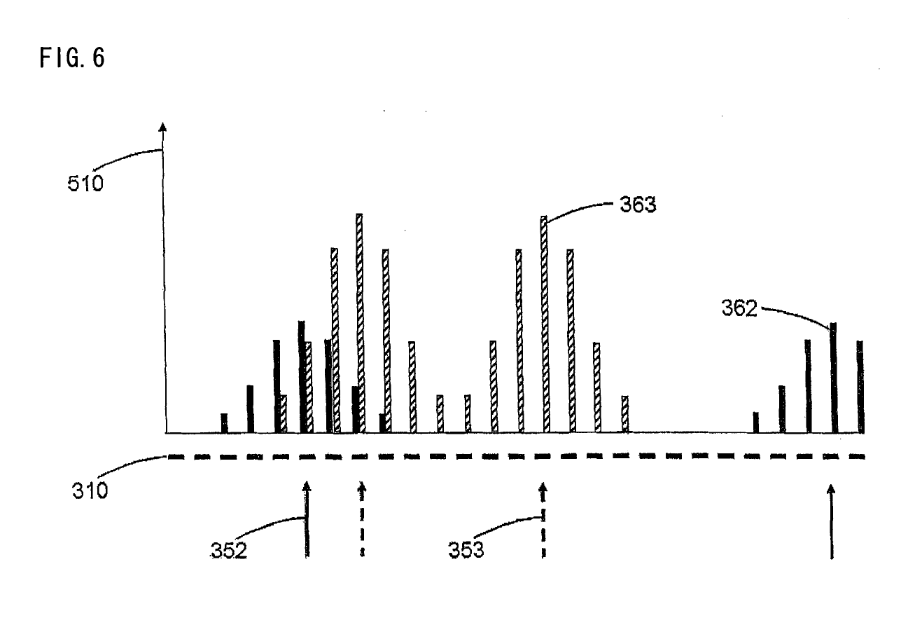

FIG. 6 illustrates the imperfect case where the bi-directionality in the field of view of sensors 310 is not angularly narrow, so that an electric signal is induced through more than two sensors 310.

Because the field of view of sensors 310 is not narrow in this case, sensors 310 adjacent to maxima of signal at positions 352 for object 402 and at positions 353 for object 403 are illuminated by light scattered/emitted by object 402 or 403 that induces an electric signal through the adjacent sensors, resulting in a sensor 310 signal bi-distribution for each scattering/emitting object symmetric around their position relative to the (X,Y) axis of reference 500 from FIG. 2 and of which the separation distance of its maxima is linearly related to the height of the scattering/emitting object. Maximum sensor responses for the objects 402 and 403 are indicated at 362 and 363, respectively, as light amplitude 510 against the sensor position.

3D Detection

FIG. 7.a illustrates the same principle as in FIG. 6, but using a contour visualisation of the signals generated by light scattered/emitted by objects 402 or 403 inducing an electric signal through a plurality of sensors 310, thus forming a pixelated image.

In this, the relative positions of scattering/emitting objects are obtained by considering the following:

X Position Relatively to Reference 500:

Each scattering/emitting object that scatters/emits light within the field of view of each sensor may contribute to generate a symmetric pattern in the image resulting from their interaction with the display. X position relative to reference 500 is calculated as the median position 352 in the X direction of the resulting symmetric pattern.

Y Position Relatively to Reference 500:

Similarly, Y position relative to reference 500 is calculated as the median position 353 in the Y direction of the resulting symmetric pattern.

Z Position Relatively to Reference 500:

Z position relative to reference 500 is linearly dependent with spacing d402 or d403, defined in terms of pixels number or distance according to one of or a combination of the axis X or Y in the reference 500. A measure of d402 or d403 is obtained by estimating the position of the maxima within the symmetric pattern generated by the scattering/emitting objects interacting with the display.

Thus X, Y and Z coordinates within reference 500 are obtained in relation to the position of scattering/emitting objects interacting with the display.

FIG. 7.b illustrates experimental results obtained with the technique mentioned above. In this, the Z position relative to reference 500 of a light emitting object is plotted with respect to the spacing between two maxima of the symmetric pattern resulting from signals generated through sensors 310 constituted by an array of 64×64 sensors separated by a distance of 84 microns in the X and Y directions of reference 500, of which field of view is identical to the one depicted in FIG. 3 and FIG. 4.

The particular arrangement depicted in FIG. 7.a constitutes a mere example to which this embodiment is not restricted, which can also incorporate regularly spaced sensors 310 with various forms of aperture layers 321 and/or 331 as depicted in FIG. 4, or irregularly spaced sensors 310 with various forms of aperture layers 321 and/or 331 as depicted in FIG. 4.

Additionally, sensors 310 can also be mixed with other types of sensors performing a function similar to the two- or three-dimensional detection of objects above, on or below the display panel 100 surface with reference to reference 500, or can also be mixed with other types of sensors embedded in the same TFT matrix 300 performing a different function from the two- or three-dimensional detection of objects above, on or below the display panel 100 surface with reference to reference 500, such as pressure sensitive sensors using resistive, projected capacitors, surface capacitive, active digitizer, surface acoustic wave techniques as means of detecting locally a physically measurable quantity such as pressure, temperature, electrostatic charge, chemical composition, tilt, orientation, magnetic fields, light intensity or wavelength of incident light.

Additionally, if the LCD display panel 100 surface is made of a flexible material that allows for local deformations when submitted to pressure effected by one or many light scattering or light emitting objects, TFT embedded light sensor array 300 may also provide three-dimensional detection of the position of the one or many light scattering or light emitting objects effecting pressure on the LCD display panel 100 surface below the LCD display panel 100 surface, resulting in negative positional information relatively to the axis Z of reference 500, normal to the LCD display panel 100 surface.

### Embodiment 2

Another embodiment of the present invention is illustrated in FIGS. 8.a, 8.b and 8.c whereby a mono-directional field of view on sensor 310 is created through an aperture layer 332 similar to layer 331 from FIG. 3, with a width W332 which may be of rectangular, square, circular, elliptic or arbitrary shape having the effect of optically restricting the field of view of sensor 310 in a similar manner as layer 321 depicted in FIG. 3.

In FIG. 8.a, the aperture layer 332 is centrally positioned with respect to sensor 310 so as to create a field of view that accepts central incidence light 605 relatively to the display panel 100 surface.

In FIG. 8.b, the aperture layer 333 is positioned shifted to the right with respect to sensor 310 so as to create a field of view that mainly accepts right-oblique incidence light 604 relatively to the display panel 100 surface.

In FIG. 8.c, the aperture layer 334 is positioned shifted to the left with respect to sensor 310 so as to create a field of view that mainly accepts rays at left-oblique incidence 604 on the display panel 100 surface.

Thus, any combination of these to create a central, left-oblique or right-oblique incidence field of view on sensor 310 can be implemented, with no restriction to their relative positioning in the (X,Y) plane of reference 500.

In this way, individual sensors 310 having any central, left-oblique or right-oblique incidence field of view in the Y direction of reference 500 can be combined with other sensors 310 having any central, left-oblique or right-oblique incidence field of view in the X direction of reference 500. A particular configuration of this is described in FIG. 8.e.

In particular, three-dimensional detection of position of light scattering/emitting objects can also be obtained using the same technique described in FIG. 5 and FIG. 6 by combining the pixelated images obtained from signals generated through left-oblique incidence and right-oblique incidence on sensors 310.

Additionally, embodiment 2 described in FIGS. 8.a, 8.b and 8.c can also include layer 321 described in FIG. 3 of the main embodiment.

The particular arrangement depicted in FIGS. 8.a, 8.b, 8.c constitutes a mere example to which this embodiment is not restricted, which can also incorporate regularly spaced sensors 310 with various forms of aperture layers 332, 333 and 334 in a manner similar to layer 331 depicted in FIG. 4, or irregularly spaced sensors 310 with various forms of aperture layers 332, 333 and 334 in a manner similar to layer 331 depicted in FIG. 4.

Additionally, sensors 310 can also be mixed with other types of sensors performing a function similar to the two- or three-dimensional detection of objects above, on or below the display panel 100 surface with reference to reference 500, or can also be mixed with other types of sensors embedded in the same TFT matrix 300 performing a different function from the two- or three-dimensional detection of objects above, on or below the display panel 100 surface with reference to reference 500, such as pressure sensitive sensors using resistive, projected capacitors, surface capacitive, active digitizer, surface acoustic wave techniques as means of detecting locally a physically measurable quantity such as pressure, temperature, electrostatic charge, chemical composition, tilt, orientation, magnetic fields, light intensity or wavelength of incident light.

Additionally, there is no restriction for this embodiment in the wavelength of light incident on sensor 310, apart from being included within the sensor chromatic sensitivity. This embodiment may use a very narrow range of wavelengths such as in a Laser source or a plurality of Laser sources or a broad range of wavelengths.

### Embodiment 3

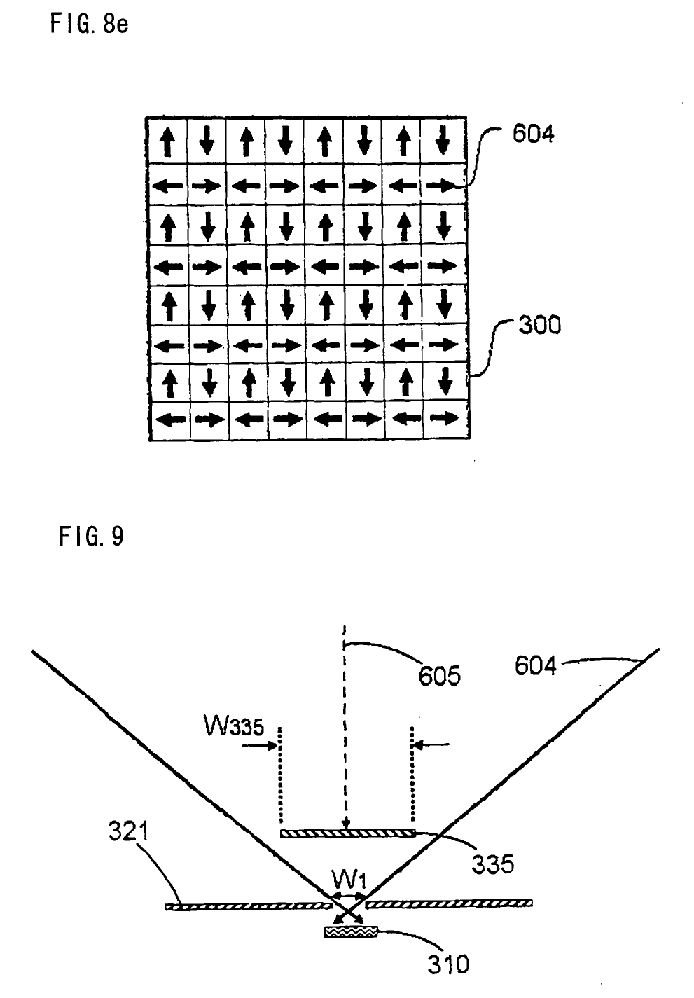

Another embodiment of the present invention is illustrated in FIG. 9, whereby a bi-directional field of view is created on sensor 310.

In this embodiment, central incidence light is blocked by layer 335, constituting a mask of width W335 which may be of rectangular, square, circular, elliptic or arbitrary shape, thus creating a bi-directional field of view on sensor 310.

Layer 321 in this embodiment is identical to its description made in FIG. 3.

The effect of the central mask constituted by layer 335 is to eliminate mainly central incidence light 605, while allowing a full angular spread of right- and left-oblique incidence light 604 on sensor 310. In particular, three-dimensional detection of position of light scattering/emitting objects can also be obtained using the same technique described in FIG. 5 and FIG. 6.

The particular arrangement depicted in FIG. 9 constitutes a mere example to which this embodiment is not restricted, which can also incorporate regularly spaced sensors 310 with various forms of aperture layers 321 and/or 335 in a manner similar to layers 321 and 331 depicted in FIG. 4, or irregularly spaced sensors 310 with various forms of aperture layers 321 and/or 335 in a manner similar to layers 321 and 331 depicted in FIG. 4.

Additionally, sensors 310 can also be mixed with other types of sensors performing a function similar to the two- or three-dimensional detection of objects above, on or below the display panel 100 surface with reference to reference 500, or can also be mixed with other types of sensors embedded in the same TFT matrix 300 performing a different function from the two- or three-dimensional detection of objects above, on or below the display panel 100 surface with reference to reference 500, such as pressure sensitive sensors using resistive, projected capacitors, surface capacitive, active digitizer, surface acoustic wave techniques as means of detecting locally a physically measurable quantity such as pressure, temperature, electrostatic charge, chemical composition, tilt, orientation, magnetic fields, light intensity or wavelength of incident light.

Additionally, there is no restriction for this embodiment in the wavelength of light incident on sensor 310, apart from being included within the sensor chromatic sensitivity. This embodiment may use a very narrow range of wavelengths such as in a Laser source or a plurality of Laser sources or a broad range of wavelengths.

### Embodiment 4

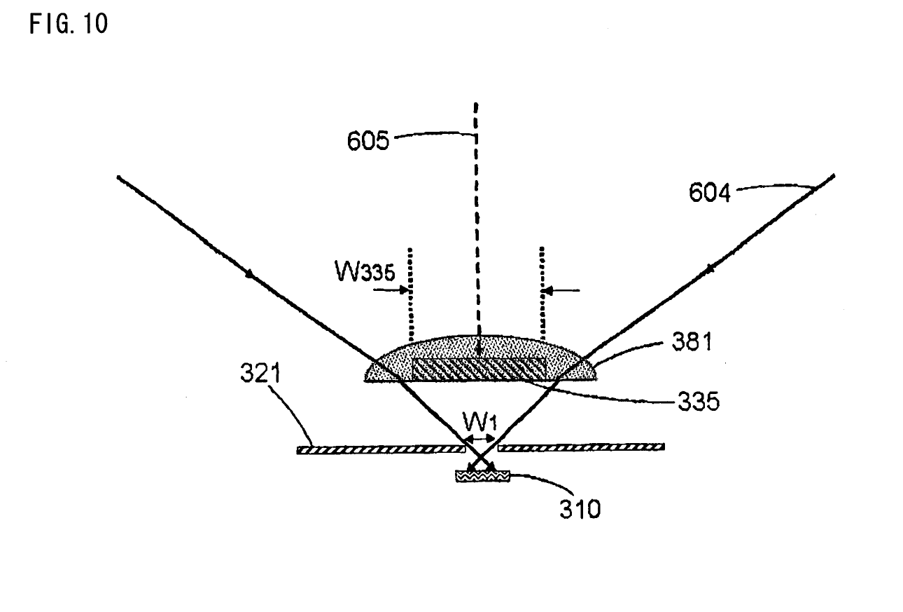

Another embodiment of the present invention is illustrated in FIG. 10, whereby a bi-directional field of view is created on sensor 310.

In this embodiment, central incidence light is blocked by layer 335, constituting a mask of width W335 which may be of rectangular, square, circular, elliptic or arbitrary shape, thus creating a bi-directional field of view on sensor 310.

Layer 321 in this embodiment is identical to its description made in FIG. 3. The effect of the central mask constituted by layer 335 is to eliminate mainly central incidence light 605, while allowing a full angular spread of right- and left-oblique incidence light 604 on sensor 310.

In this embodiment, the height of layer 335 is significantly increased so as to allow the formation of a lens-type structure when depositing material 381 having a significantly different refractive index from its embedding medium.

In this way, the bi-directionality created on sensor 310 is more clearly defined and a higher amount of left- and right-oblique incidence light 604 is collected to induce a stronger signal through sensor 310.

Additionally, layer 335 may not be increased but still perform the function of eliminating mainly central incidence light 605, while the lens-type structure may be achieved using the liquid crystal layer 102 depicted in FIG. 3 in which voltage driven micro-pins may create a radial alignment of the liquid crystal molecules, thereby effecting a virtual lens by a change of refractive index induced by the radial alignment of the liquid crystal molecules.

In particular, three-dimensional detection of position of light scattering/emitting objects can also be obtained using the same technique described in FIG. 5 and FIG. 6.

The particular arrangement depicted in FIG. 10 constitutes a mere example to which this embodiment is not restricted, which can also incorporate regularly spaced sensors 310 with various forms of aperture layers 321 and/or 335 in a manner similar to layers 321 and 331 depicted in FIG. 4, or irregularly spaced sensors 310 with various forms of aperture layers 321 and/or 335 in a manner similar to layers 321 and 331 depicted in FIG. 4.

Additionally, sensors 310 can also be mixed with other types of sensors performing a function similar to the two- or three-dimensional detection of objects above, on or below the display panel 100 surface with reference to reference 500, or can also be mixed with other types of sensors embedded in the same TFT matrix 300 performing a different function from the two- or three-dimensional detection of objects above, on or below the display panel 100 surface with reference to reference 500, such as pressure sensitive sensors using resistive, projected capacitors, surface capacitive, active digitizer, surface acoustic wave techniques as means of detecting locally a physically measurable quantity such as pressure, temperature, electrostatic charge, chemical composition, tilt, orientation, magnetic fields, light intensity or wavelength of incident light.

Additionally, there is no restriction for this embodiment in the wavelength of light incident on sensor 310, apart from being included within the sensor chromatic sensitivity. This embodiment may use a very narrow range of wavelengths such as in a Laser source or a plurality of Laser sources or a broad range of wavelengths.

### Embodiment 5

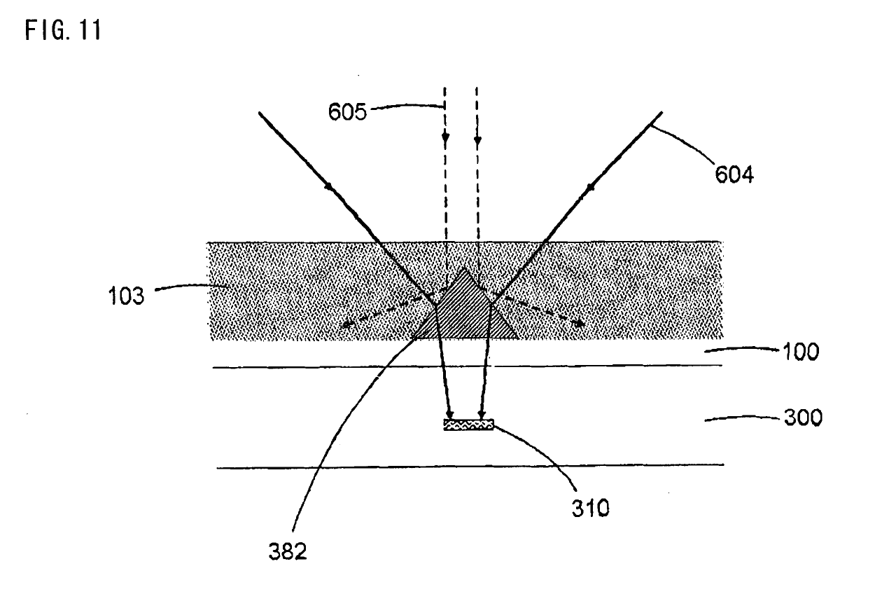

Another embodiment of the present invention is illustrated in FIG. 11, whereby a prism structure 382 is inserted within one of the layers of TFT matrix 300 or LCD display panel 100.

Constituted by material of a refractive index smaller than its embedding layer, prism structure 382 effects a total internal reflection of centrally incident light 605, therefore shielding sensor 310 from centrally incident light 605, but allowing left- and right-oblique incidence light 604 to propagate through to sensor 310 by ordinary refraction process.

In particular, three-dimensional detection of position of light scattering/emitting objects can also be obtained using the same technique described in FIG. 5 and FIG. 6.

The particular arrangement depicted in FIG. 11 constitutes a mere example to which this embodiment is not restricted, which can also incorporate regularly spaced sensors 310 with various forms of structures inducing total internal reflection of central incidence light 605 so as to shield sensor 310 from it, or irregularly spaced sensors 310 with various forms of structures inducing total internal reflection of central incidence light 605 so as to shield sensor 310 from it.

Additionally, sensors 310 can also be mixed with other types of sensors performing a function similar to the two- or three-dimensional detection of objects above, on or below the display panel 100 surface with reference to reference 500, or can also be mixed with other types of sensors embedded in the same TFT matrix 300 performing a different function from the two- or three-dimensional detection of objects above, on or below the display panel 100 surface with reference to reference 500, such as pressure sensitive sensors using resistive, projected capacitors, surface capacitive, active digitizer, surface acoustic wave techniques as means of detecting locally a physically measurable quantity such as pressure, temperature, electrostatic charge, chemical composition, tilt, orientation, magnetic fields, light intensity or wavelength of incident light.

Additionally, there is no restriction for this embodiment in the wavelength of light incident on sensor 310, apart from being included within the sensor chromatic sensitivity. This embodiment may use a very narrow range of wavelengths such as in a Laser source or a plurality of Laser sources or a broad range of wavelengths.

### Embodiment 6

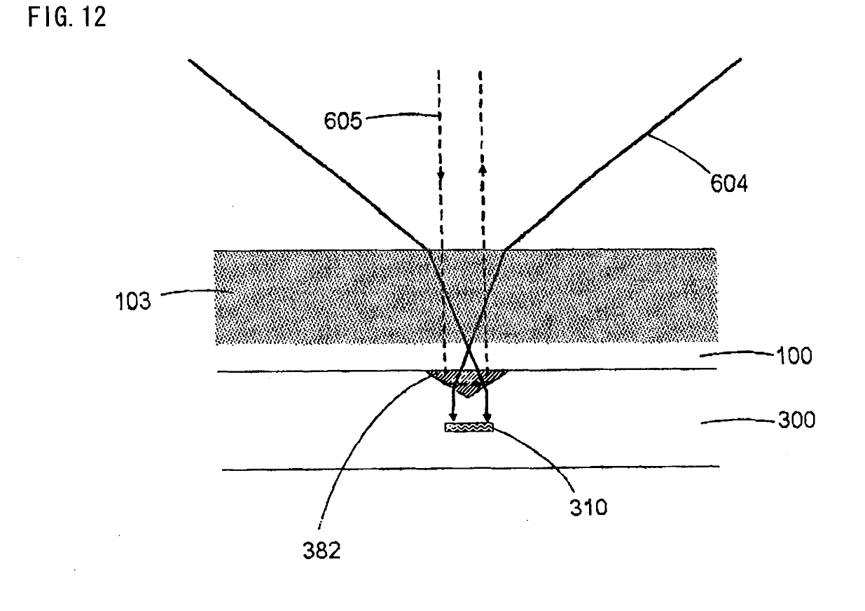

Another embodiment of the present invention is illustrated in FIG. 12, whereby a prism structure 382 is inserted within one of the layers of TFT matrix 300 or LCD display panel 100.

Constituted by material 382 of a refractive index higher than its embedding layer, prism structure 382 effects a total internal reflection of centrally incident light 605 that reflects it back, therefore shielding sensor 310 from centrally incident light 605, but allowing left- and right-oblique incidence light 604 to propagate through to sensor 310 by ordinary refraction process.

In particular, three-dimensional detection of position of light scattering/emitting objects can also be obtained using the same technique described in FIG. 5 and FIG. 6.

The particular arrangement depicted in FIG. 12 constitutes a mere example to which this embodiment is not restricted, which can also incorporate regularly spaced sensors 310 with various forms of structures inducing total internal reflection of central incidence light 605 so as to shield sensor 310 from it, or irregularly spaced sensors 310 with various forms of structures inducing total internal reflection of central incidence light 605 so as to shield sensor 310 from it.

Additionally, sensors 310 can also be mixed with other types of sensors performing a function similar to the two- or three-dimensional detection of objects above, on or below the display panel 100 surface with reference to reference 500, or can also be mixed with other types of sensors embedded in the same TFT matrix 300 performing a different function from the two- or three-dimensional detection of objects above, on or below the display panel 100 surface with reference to reference 500, such as pressure sensitive sensors using resistive, projected capacitors, surface capacitive, active digitizer, surface acoustic wave techniques as means of detecting locally a physically measurable quantity such as pressure, temperature, electrostatic charge, chemical composition, tilt, orientation, magnetic fields, light intensity or wavelength of incident light.

Additionally, there is no restriction for this embodiment in the wavelength of light incident on sensor 310, apart from being included within the sensor chromatic sensitivity. This embodiment may use a very narrow range of wavelengths such as in a Laser source or a plurality of Laser sources or a broad range of wavelengths.

### Embodiment 7

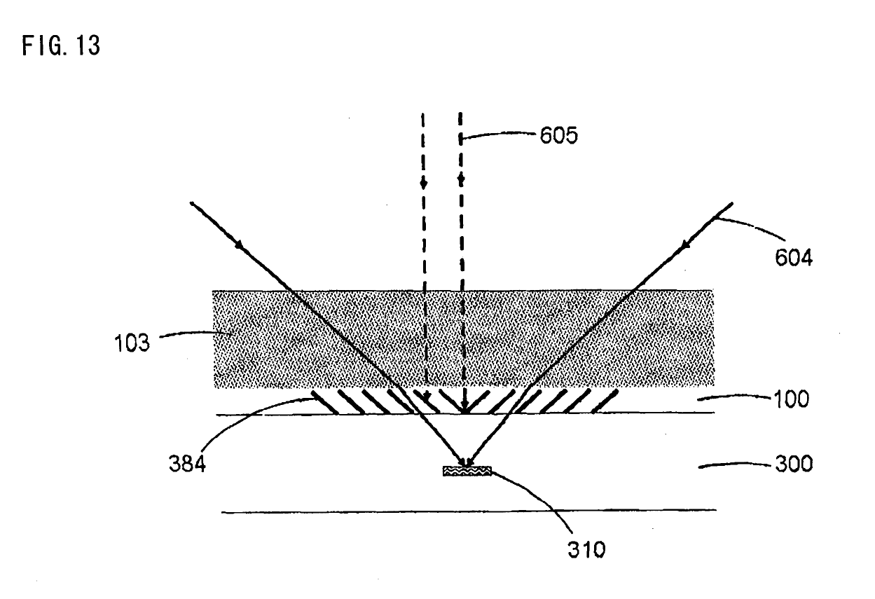

Another embodiment of the present invention is illustrated in FIG. 13, whereby a structure comprising angled absorbing masks 384, which function is to absorb centrally incidence light 605, therefore shielding sensor 310 from centrally incident light 605, but allowing left- and right-oblique incidence light 604 to propagate through to sensor 310 without being absorbed, is inserted within one of the layers of TFT matrix 300 or LDC display panel 100. The masks 384 constitute louvres.

In particular, three-dimensional detection of position of light scattering/emitting objects can also be obtained using the same technique described in FIG. 5 and FIG. 6.

The particular arrangement depicted in FIG. 13 constitutes a mere example to which this embodiment is not restricted, which can also incorporate regularly spaced sensors 310 with various forms of structures inducing total internal reflection of central incidence light 605 so as to shield sensor 310 from it, or irregularly spaced sensors 310 with various forms of structures inducing total internal reflection of central incidence light 605 so as to shield sensor 310 from it.

Additionally, sensors 310 can also be mixed with other types of sensors performing a function similar to the two- or three-dimensional detection of objects above, on or below the display panel 100 surface with reference to reference 500, or can also be mixed with other types of sensors embedded in the same TFT matrix 300 performing a different function from the two- or three-dimensional detection of objects above, on or below the display panel 100 surface with reference to reference 500, such as pressure sensitive sensors using resistive, projected capacitors, surface capacitive, active digitizer, surface acoustic wave techniques as means of detecting locally a physically measurable quantity such as pressure, temperature, electrostatic charge, chemical composition, tilt, orientation, magnetic fields, light intensity or wavelength of incident light.

Additionally, there is no restriction for this embodiment in the wavelength of light incident on sensor 310, apart from being included within the sensor chromatic sensitivity. This embodiment may use a very narrow range of wavelengths such as in a Laser source or a plurality of Laser sources or a broad range of wavelengths.

### Embodiment 8

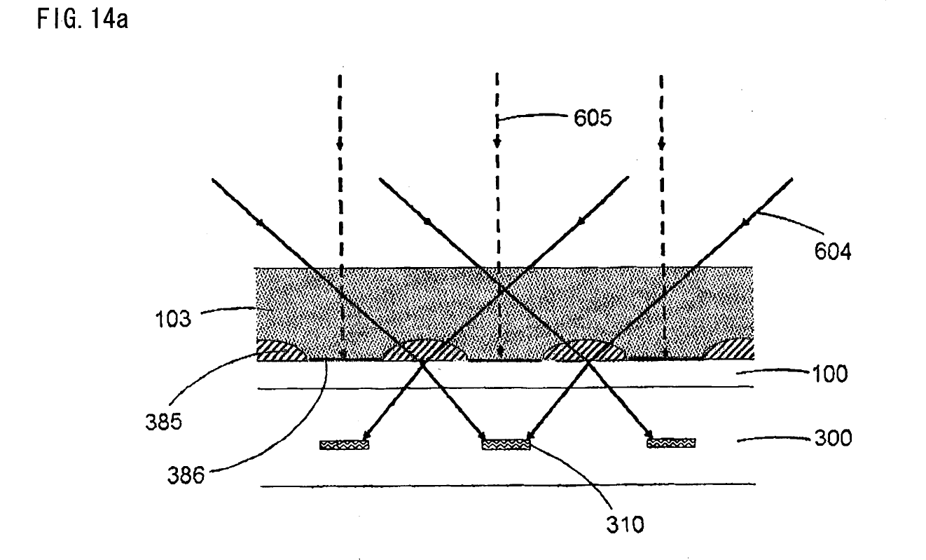

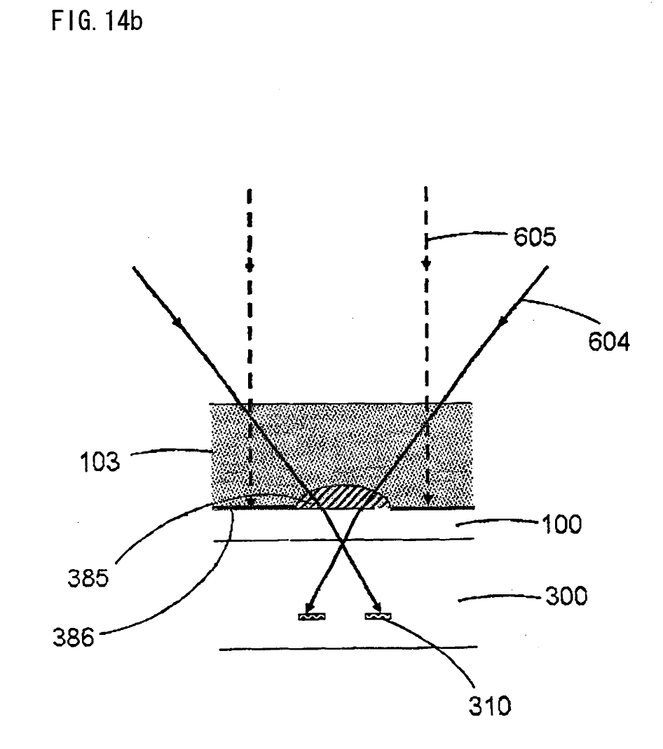

Another embodiment of the present claim is illustrated in FIG. 14.a, whereby one or many lens structures 385 are inserted within the TFT matrix 300 or LCD display panel 100 at a position adjacent to one or many masks 386 having the effect of blocking the central incidence light 605, while lens 385 images on adjacent sensors 310 right- and left-oblique incidence light 604.

Another embodiment of the present invention is illustrated in FIG. 14.b, whereby one or many lens structures 385 are inserted within the TFT matrix 300 or LCD display panel 100 at a position adjacent to one or many masks 386 having the effect of blocking the central incidence light 605, while lens 385 images on two adjacent sensors 310 respectively right- and left-oblique incidence light 604. In this embodiment, one or many lens structures 385 can also be inserted within the TFT matrix 300 or LCD display panel 100 at a position relative to sensor 310 so as to create only one field of view per sensor.

In particular, three-dimensional detection of position of light scattering/emitting objects can also be obtained using the same technique described in FIG. 5 and FIG. 6.

The particular arrangement depicted in FIG. 14 constitutes a mere example to which this embodiment is not restricted, which can also incorporate regularly spaced sensors 310 with various forms of structures to block central incidence light 605 so as to shield sensor 310 from it, or irregularly spaced sensors 310 with various forms of structures to block central incidence light 605 so as to shield sensor 310 from it.

Additionally, sensors 310 can also be mixed with other types of sensors performing a function similar to the two- or three-dimensional detection of objects above, on or below the display panel 100 surface with reference to reference 500, or can also be mixed with other types of sensors embedded in the same TFT matrix 300 performing a different function from the two- or three-dimensional detection of objects above, on or below the display panel 100 surface with reference to reference 500, such as pressure sensitive sensors using resistive, projected capacitors, surface capacitive, active digitizer, surface acoustic wave techniques as means of detecting locally a physically measurable quantity such as pressure, temperature, electrostatic charge, chemical composition, tilt, orientation, magnetic fields, light intensity or wavelength of incident light.

Additionally, there is no restriction for this embodiment in the wavelength of light incident on sensor 310, apart from being included within the sensor chromatic sensitivity. This embodiment may use a very narrow range of wavelengths such as in a Laser source or a plurality of Laser sources or a broad range of wavelengths.

### Embodiment 9

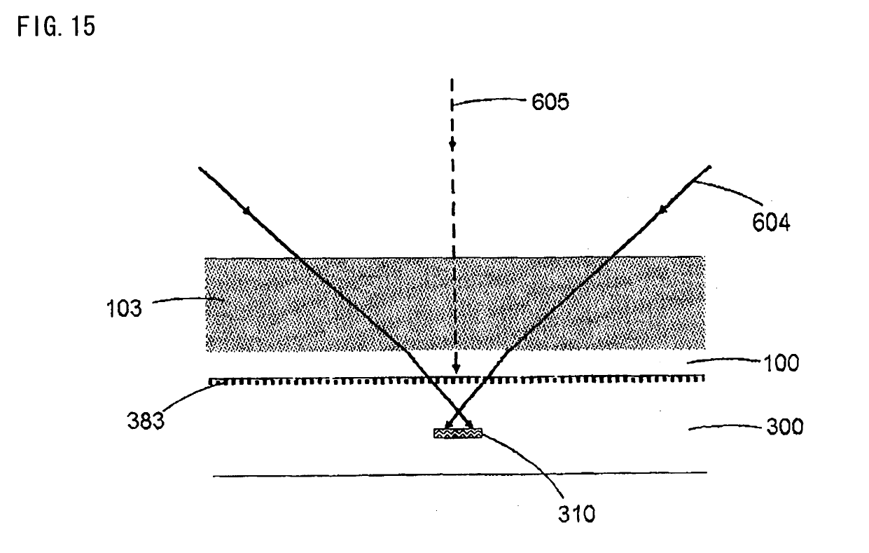

Another embodiment of the present invention is illustrated in FIG. 15, whereby a wire-grid element 383 is inserted within the TFT matrix 300 or LCD display panel 100 above the sensor so as to in-couple left- or right-incidence light 604 by means of diffraction, blocking the central incidence light 605.

In particular, three-dimensional detection of position of light scattering/emitting objects can also be obtained using the same technique described in FIG. 5 and FIG. 6.

The particular arrangement depicted in FIG. 15 constitutes a mere example to which this embodiment is not restricted, which can also incorporate regularly spaced sensors 310 with various forms of additional structures to block central incidence light 605 so as to shield sensor 310 from it, or irregularly spaced sensors 310 with various forms of additional structures to block central incidence light 605 so as to shield sensor 310 from it.

Additionally, sensors 310 can also be mixed with other types of sensors performing a function similar to the two- or three-dimensional detection of objects above, on or below the display panel 100 surface with reference to reference 500, or can also be mixed with other types of sensors embedded in the same TFT matrix 300 performing a different function from the two- or three-dimensional detection of objects above, on or below the display panel 100 surface with reference to reference 500, such as pressure sensitive sensors using resistive, projected capacitors, surface capacitive, active digitizer, surface acoustic wave techniques as means of detecting locally a physically measurable quantity such as pressure, temperature, electrostatic charge, chemical composition, tilt, orientation, magnetic fields, light intensity or wavelength of incident light.

Additionally, there is no restriction for this embodiment in the wavelength of light incident on sensor 310, apart from being included within the sensor chromatic sensitivity. This embodiment may use a very narrow range of wavelengths such as in a Laser source or a plurality of Laser sources or a broad range of wavelengths.

### Embodiment 10

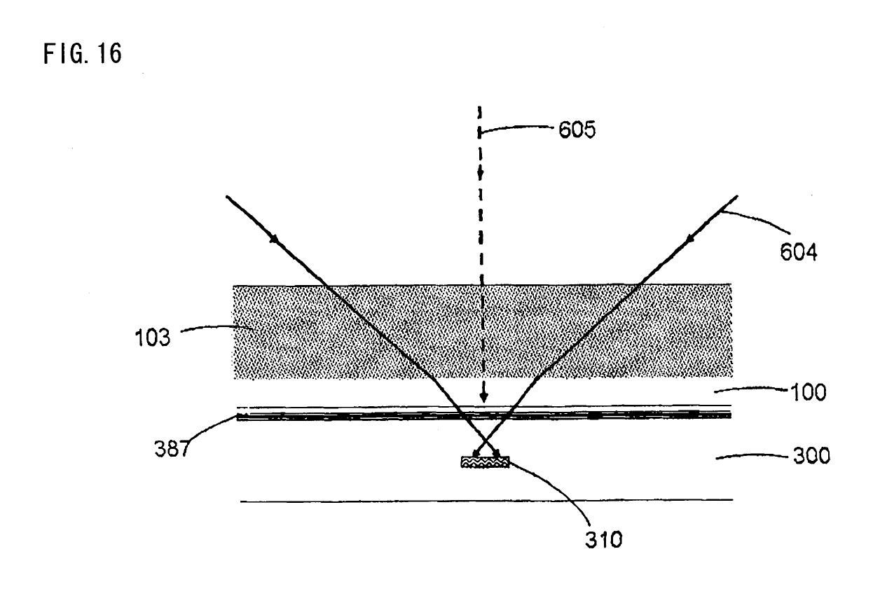

Another embodiment of the present invention is illustrated in FIG. 16, whereby element 387, constituted by a stack of interference filters, is inserted within the TFT matrix 300 or LCD display panel 100 above the sensor, and designed so as to in-couple left- or right-incidence light 604 by means of diffraction and to block the central incidence light 605.

As interference filters are usually very wavelength selective, element 387 may be designed accordingly to the wavelength of light being used to illuminate scattering objects interacting with the display, or accordingly to the wavelength of light emitted by emitting objects interacting with the display.

In particular, three-dimensional detection of position of light scattering/emitting objects can also be obtained using the same technique described in FIG. 5 and FIG. 6.

The particular arrangement depicted in FIG. 16 constitutes a mere example to which this embodiment is not restricted, which can also incorporate regularly spaced sensors 310 with various forms of additional structures to block central incidence light 605 so as to shield sensor 310 from it, or irregularly spaced sensors 310 with various forms of additional structures to block central incidence light 605 so as to shield sensor 310 from it.

Additionally, sensors 310 can also be mixed with other types of sensors performing a function similar to the two- or three-dimensional detection of objects above, on or below the display panel 100 surface with reference to reference 500, or can also be mixed with other types of sensors embedded in the same TFT matrix 300 performing a different function from the two- or three-dimensional detection of objects above, on or below the display panel 100 surface with reference to reference 500, such as pressure sensitive sensors using resistive, projected capacitors, surface capacitive, active digitizer, surface acoustic wave techniques as means of detecting locally a physically measurable quantity such as pressure, temperature, electrostatic charge, chemical composition, tilt, orientation, magnetic fields, light intensity or wavelength of incident light.

Additionally, there is no restriction for this embodiment in the wavelength of light incident on sensor 310, apart from being included within the sensor chromatic sensitivity. This embodiment may be used only with a very narrow range of wavelengths such as in a Laser source.

As previously mentioned, each embodiment of the invention includes a processor of the type shown at 800 in FIG. 2. The processor may form part of the display or may be associated with it or connected to it in any suitable way. The processor determines the position of the object as Cartesian components with respect to first and second axis (x and y as shown in FIG. 2) in the display surface and a third axis (z as shown in FIG. 2) perpendicular to and with an origin (0,0,0) at the display surface.

In the embodiments described hereinbefore, the arrangements in front of the sensors cooperate with the sensors so as to restrict the angle of view of each sensor. The arrangements thus cooperate with the sensors to define a plurality of sets of the sensors such that the sensors of each set have the same angle of view and sensors of different sets have different angles of view. Such angles of view are illustrated, for example, in FIG. 3b, FIG. 5, FIG. 8b, FIG. 8c and FIGS. 9 to 16 by the ray paths or directions 604. FIGS. 8d and 8e give examples of the azimuths of the angles of view of the sensors for two particular examples of sensor arrangements. A description of the operation of the processor to determine the object position will be given for a panel of the type whose sensors have angles of view with azimuths as illustrated in FIG. 8e.

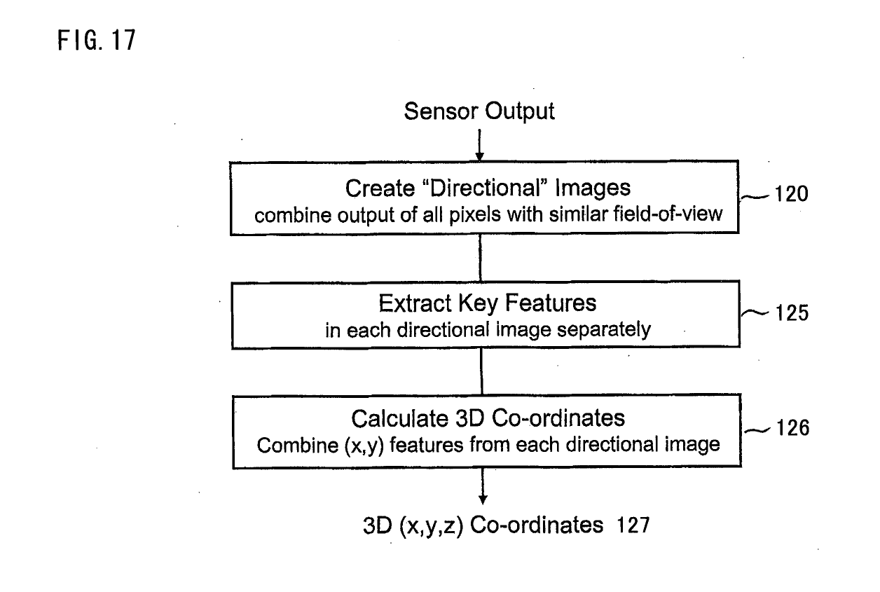

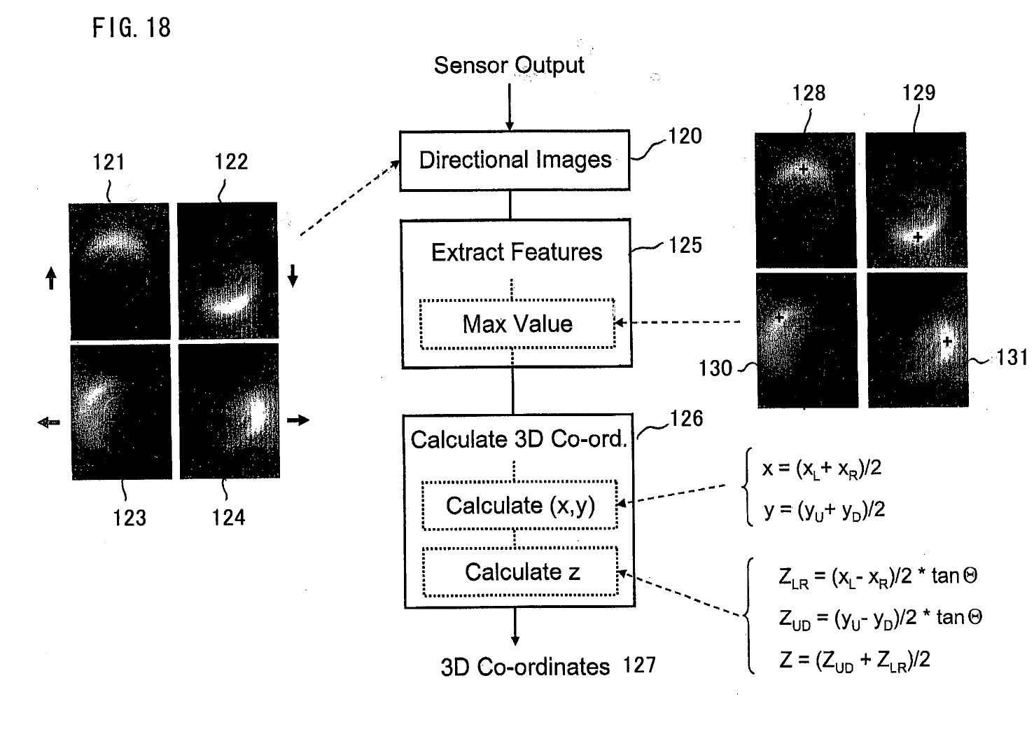

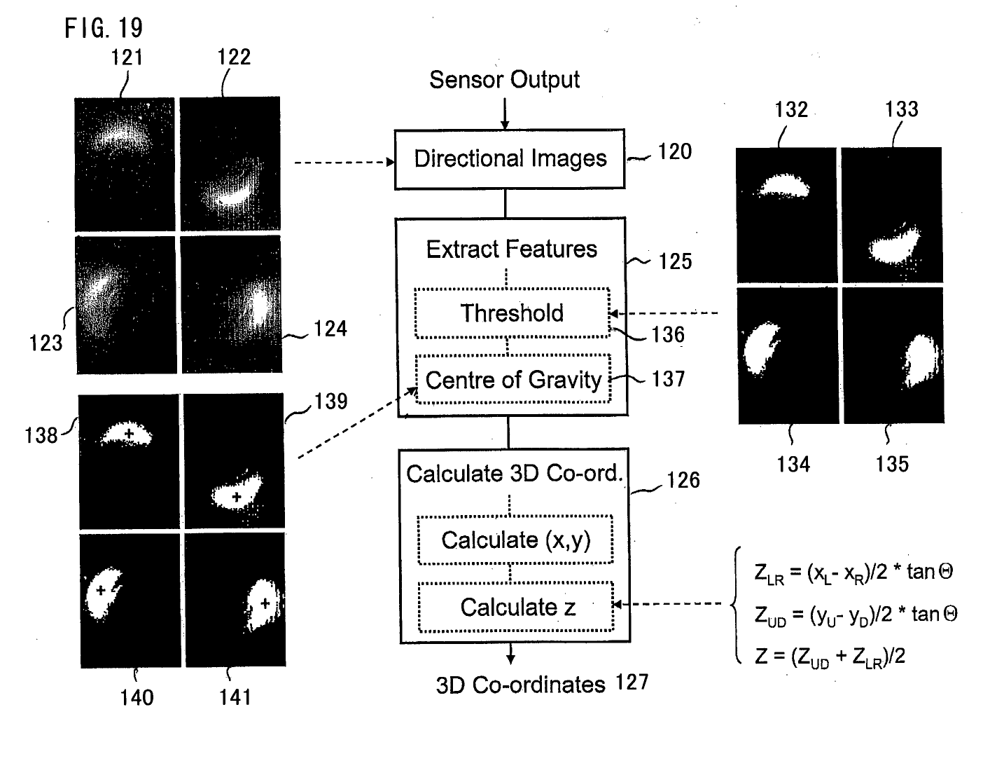

The processor performs the method illustrated by the flow diagram in FIG. 17. Thus, the processor receives the sensor output by any suitable means and in any suitable format. For example, the sensors may be subjected to a scanning operation to supply their outputs to the processor using active matrix scanning techniques, which are well known. In a first step 120, “directional” images are created by associating together the outputs of the sensors which are members of the same sets and have the same angles of view. Examples of such directional images are illustrated in FIGS. 18 and 19. In particular, the image 121 is formed by those sensors which look down relative to the display surface normal (which is assumed to be oriented horizontally), the image 122 is formed by those sensors which look up relative to the display surface normal, the image 123 is formed by those sensors which look right relative to the display surface and the image 124 is formed by those sensors which look left relative to the display surface normal.

The processor then processes each of the images 121-124 separately or individually in order to extract “key” visual features of the image. In particular, the processor processes the images to determine the location of a key feature. The results are then used in a step 126 to calculate the three dimensional (3D) coordinates of the object relative to the Cartesian axes at the display surface. For example, the processor determines the x and y coordinates of the position of the object from each directional image 121-124 and determines from this the z coordinate of the object so as to provide the 3D position as x, y and z coordinates 127.

A specific example of the processing technique shown in FIG. 17 is illustrated in FIG. 18. In this example, the extraction performed by the step 125 is to determine the highest value of light intensity sensed by the sensors in each of the images 121-124 so as to determine the position of the sensor measuring the highest light intensity. The position of the highest value or intensity of light is determined for each of the images 121-124 and the position of each highest intensity sensor in the display surface is illustrated by a cross in each of the images 128-131. In the image 128, the location of the sensor measuring the highest light intensity is given by the coordinates (x_{D}, y_{D}). In the image 129, the position of the sensor measuring the highest light intensity is (x_{U}, y_{U}). Similarly, the positions of highest light intensities are given by the coordinates (x_{R}, y_{R}) and (x_{L}, y_{L}) in the images 130 and 131, respectively.

In the step 126, the (x and y) coordinates of the position of the object relative to the display screen are calculated as the average or mean position between the coordinates x_{L} and x_{R} in the x direction and yᵤ and y_{D} in the y direction. Thus, the x coordinate of the object position is given by x=(x_{L}+x_{R})/2 and the y coordinate of the object position is given by (y_{U}+y_{D})/2.

It is assumed that all of the sensors of the panel have the same elevation angle θ of view relative to the display surface, although this is not essential so long as the angle of view is known. For example, the elevation angles may be different between the sensors responding parallel to the x and y directions.

In the example where all the elevation angles are the same and equal to θ, then the z coordinate of the object position is calculated as follows. The distances between the locations of the light intensity maximum in the images are formed as (x_{L}−x_{R}) and (y_{U}−y_{D}). These distances are then used to form first and second z object positions according to the expressions:

Z_{LR}=(X_{L}−X_{R})/2*tan θ

Z_{UD}=(y_{U}−y_{D})/2*tan θ.

The z coordinate of the object position is then determined as the mean or average of these two values (Z_{UD}+Z_{LR})/2.

FIG. 19 illustrates another example of the processing technique performed by the processor so as to determine the three dimensional position of the object. The technique illustrated in FIG. 19 differs from that illustrated in FIG. 18 in respect of the feature extraction step 125. In the technique of FIG. 19, the images 121-124 are first subjected to a thresholding step so as to produce the thresholded images 132-135, respectively. In particular, the output of each sensor is compared with a threshold, which may be determined in any suitable way, and the actual sensed intensity value is replaced in the directional image by a first predetermined value, such as 1, if the sensed intensity is greater than the threshold and by a second predetermined value, such as 0, if the sensed intensity is less than or equal to the threshold. The thresholding step is indicated at 136 and is followed by a “centre of gravity” or centre of light intensity forming step 137. In particular, each of the images 132-135 is processed to find the centre of light intensity as indicated by crosses in the images 138-141, respectively. The actual process of determining the centre of light intensity is the same as the calculation of centre of gravity but with the value of light intensity replacing the value of mass.

The 3D coordinates 127 are then calculated in the step 126 in the same way as for the technique illustrated in FIG. 18. In particular, the x and y coordinates of the object position are calculated and the z coordinate of the object position is determined from this.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. A display panel for use in determining a three dimensional position of an object with respect to a display surface of the panel, comprising a plurality of light sensors spaced apart and disposed in the panel and a plurality of optical arrangements disposed in the panel, each of the arrangements being arranged to cooperate with at least one of the sensors to prevent light which is incident normally on the display surface from reaching the at least one sensor and to permit at least some light which is incident obliquely on the display surface to reach the at least one sensor, the panel comprising or being associated with a processor for determining the position of the object as Cartesian components with respect to first and second axes in the display surface and a third axis perpendicular to and with an origin at the display surface.

2. A panel as claimed in claim 1, in which each of the arrangements comprises a first aperture in a first mask.

3. A panel as claimed in claim 2, in which each of the first apertures is offset perpendicularly from a normal to the display surface passing through the at least one sensor.

4. A panel as claimed in claim 2, in which each of the first apertures contains a respective first lens structure.

5. A panel as claimed in claim 2, in which each of the first apertures is aligned normally with the at least one sensor and each of the arrangements further comprises a portion of a second mask aligned normally with the first aperture and the at least one sensor.

6. A panel as claimed in claim 5, in which each of the portions of the second mask is formed in or adjacent a respective second lens structure.

7. A panel as claimed in claim 5, in which the portions of the second mask are separated by second apertures which cooperate with the first apertures to define oblique directions from which light is permitted to reach the sensors.

8. A panel as claimed in claim 1, in which each of the arrangements comprises a prism arranged to deflect normally incident light away from the at least one sensor by total internal reflection.

9. A panel as claimed in claim 1, in which each of the arrangements comprises a plurality of louvres which are angled to define at least one oblique direction from which light is permitted to reach the at least one sensor.

10. A panel as claimed in claim 1, in which each of the arrangements comprises a diffractive arrangement.

11. A panel as claimed in claim 10, in which each of the diffractive arrangements comprises a wire grid.

12. A panel as claimed in claim 10, in which each of the arrangements comprises a plurality of interference filters.

13. A panel as claimed in claim 1, in which the sensors are sensitive to visible light.

14. A panel as claimed in claim 13, comprising a display backlight, the sensors being sensitive to light from the backlight reflected from an object in front of the display surface.

15. A panel as claimed in claim 1, in which the arrangements are arranged as a two dimensional array behind the display surface.

16. A panel as claimed in claim 1, in which each of the arrangements cooperates with the at least one sensor such that the at least one sensor receives light incident on the display surface in substantially only first and second solid angles substantially centred on first and second directions, respectively, which are on opposite sides of the display surface normal and in an azimuthal plane substantially perpendicular to the display surface.

17. A panel as claimed in claim 16, in which the first and second directions are substantially symmetrical about the display normal.

18. A panel as claimed in claim 15, in which each of the arrangements cooperates with the at least one sensor such that the at least one sensor receives light incident on the display surface in substantially only first and second solid angles substantially centred on first and second directions, respectively, which are on opposite sides of the display surface normal and in an azimuthal plane substantially perpendicular to the display surface, and in which the array comprises a first subarray whose azimuthal planes are parallel to each other and a second subarray whose azimuthal planes are perpendicular to the azimuthal planes of the first subarray.

19. A panel as claimed in claim 1, in which each of the arrangements cooperates with the at least one sensor such that the at least one sensor receives light incident on the display surface in substantially only one solid angle substantially centred on a predetermined direction.

20. A panel as claimed in claim 15, in which each of the arrangements cooperates with the at least one sensor such that the at least one sensor receives light incident on the display surface in substantially only one solid angle substantially centred on a predetermined direction, and in which the array comprises first to fourth subarrays with the azimuthal components of the predetermined directions of the second to fourth subarrays being disposed at substantially 90°, 180° and 270°, respectively, to the azimuthal component of the predetermined direction of the first subarray.

21. A panel as claimed in claim 1, in which the arrangements cooperate with the sensors to define a plurality of sets of the sensors such that the sensors of each set have a same angle of view and the angles of view of the sensors of different ones of the sets are different.

22. A panel as claimed in claim 21, in which the processor is arranged to analyse outputs of the sensors of each set for a visual feature of an image to which the set of sensors is sensitive and determines the position of the object from the visual features.

23. A panel as claimed in claim 22, in which the visual feature comprises the location of the sensor of the set sensing a highest light intensity.

24. A panel as claimed in claim 22, in which the visual feature comprises the location on the display surface of a centre of light intensity sensed by the sensors of the set.

25. A panel as claimed in claim 21, in which the sensors of first and second of the sets have angles of view whose azimuths are in opposite directions parallel to the first axis.

26. A panel as claimed in claim 22, in which the arrangements are arranged as a two dimensional array behind the display surface, and in which the angles of view of the sensors of the first and second sets have elevation angles of +θ1 and −θ1 and relative to the display surface and the processor is arranged to determine the component of the object position with respect to the first axis as a mean position between the positions of the visual features with respect to the first axis.

27. A panel as claimed in claim 26, in which the processor is arranged to determine the component of a first object position with respect to the third axis as (d1·tan(θ1))/2, where d1 is the distance between the visual features with respect to the first axis.

28. A panel as claimed in claim 21, in which the sensors of third and fourth of the sets have angles of view whose azimuths are in opposite directions parallel to the second axis.

29. A panel as claimed in claim 22, in which the sensors of third and fourth of the sets have angles of view whose azimuths are in opposite directions parallel to the second axis, and in which the angles of view of the sensors of the third and fourth sets have elevation angles of +θ2 and −θ2 relative to the display surface and the processor is arranged to determine the component of the object position with respect to the second axis as a mean position between the positions of the visual features with respect to the second axis.

30. A panel as claimed in claim 27, in which the sensors of third and fourth of the sets have angles of view whose azimuths are in opposite directions parallel to the second axis, in which the angles of view of the sensors of the third and fourth sets have elevation angles of +θ2 and −θ2 relative to the display surface and the processor is arranged to determine the component of the object position with respect to the second axis as a mean position between the positions of the visual features with respect to the second axis, and in which the processor is arranged to determine the component of a second object position with respect to the third axis as (d2·tan(θ2))/2, where d2 is the distance between the visual features with respect to the second axis, and to determine the object position with respect to the third axis as a mean of the first and second object positions.

31. A method of determining a three dimensional position of an object with respect to a display surface of a display panel comprising a plurality of light sensors spaced apart and disposed in the panel and a plurality of optical arrangements disposed in the panel, each of the arrangements being arranged to cooperate with at least one of the sensors to prevent light which is incident normally on the display surface from reaching the at least one sensor and to permit at least some light which is incident obliquely on the display surface to reach the at least one sensor, the method comprising determining the position of the object as Cartesian components with respect to first and second axes in the display surface and a third axis perpendicular to and with an origin at the display surface.
